(19) United States
(12) Patent Application Publication
(10) Pub. No.: US 2012/0206502 A1
(43) Pub. Date: Aug. 16, 2012

(54) Method of Driving a Display Panel and Display Apparatus for Performing the Same

(76) Inventors: Tae-Kwon Jung, Asan-si (KR); Dae-Gwang Jang, Incheon (KR); Dong-Hak Pyo, Cheonan-si (KR); Min-Ha Keum, Cheonan-si (KR); Hak-Mo Choi, Seoul (KR)

(21) Appl. No.: 13/292,645

(22) Filed: Nov. 9, 2011

(30) Foreign Application Priority Data
Feb. 14, 2011 (KR) 2011-0012614

(51) Int. Cl. G09G 5/10

(52) U.S. Cl. 345/690

(57) ABSTRACT

A method of driving a display panel determines luminance coefficients of a plurality of light emitting blocks included in a light source module using a Gaussian function. A pixel luminance is determined using the luminance coefficient and dimming levels of the light emitting block. The pixel luminance is a luminance of light provided to each pixel of the display panel. Input data compensated using the pixel luminance to generate compensated data. The pixel luminance provided to the pixels is calculated by considering the luminance change due to the adjacent light emitting blocks. Thus, the luminance of the input data is accurately displayed.

### PRIORITY STATEMENT

This application claims priority under 35 U.S.C. §119 to Korean Patent Application No. 10-2011-0012614, filed on Feb. 14, 2011 in the Korean Intellectual Property Office (KIPO), the contents of which are herein incorporated by reference in their entireties.

### BACKGROUND

1. Technical Field

The present invention relates to a display panel. More particularly, the present invention relates to a method of driving a display panel and a display apparatus for performing the method.

2. Discussion of the Related Art

Generally, a liquid crystal display (LCD) panel includes a display substrate, an opposite substrate facing the display substrate, and a liquid crystal layer disposed between the display substrate and the opposite substrate. The display substrate includes a display area and a peripheral area. The display area includes a plurality of transistors and a plurality of lines that connect the transistors. The peripheral area includes a plurality of pads through which electrical signals are applied to the lines.

As LCD panels are not capable of emitting light, an LCD apparatus including the LCD panel uses a light source module disposed below the LCD panel. The light source module may be called a backlight as it is used to provide light behind the LCD panel. However, many light source modules illuminate the LCD panel from a side. In general, light source modules such as backlights maintain a uniform luminance over the entire LCD panel regardless of the character of the image that is presently being displayed.

Recently, a local dimming method has been developed. In the local dimming method, the light source module is divided into a plurality of light emitting blocks the luminance of which are each individually controlled in accordance with a desired level of luminance for the particular block. The local dimming method adjusts the luminance of the light provided from the light source module and a transmitting rate of the LCD panel to display an original luminance of an image. The local dimming method adjusts the luminance of each light emitting block in a manner that is complementary to the adjustments to the transmitting rate of local pixels to decrease power consumption and to enhance a contrast ratio.

However, the light source of each of the light emitting blocks tends to emit light diffused in a wide area and accordingly, it is difficult to ensure that light from one block does not leak into adjacent blocks which may have a lower desired level of luminance.

### SUMMARY

Exemplary embodiments of the present invention provide a method of driving a display panel with local dimming in which pixel luminance is determined, in part, based on a luminance of light emitting blocks adjacent to each other.

Exemplary embodiments of the present invention also provide a display apparatus for performing the method.

According to an exemplary embodiment of the present invention, the method of driving a display panel determines luminance coefficients of a plurality of light emitting blocks included in a light source module using a Gaussian function. A pixel luminance is determined using the luminance coefficient and dimming levels of the light emitting block. The pixel luminance is a luminance of light provided to each pixel of the display panel. Input data are compensated using the pixel luminance to generate compensated data.

In an exemplary embodiment, intensities of the light emitting from light sources included in the light emitting blocks may be added up according to positions of the light sources to determine a light intensity of the light emitting blocks.

In an exemplary embodiment, the light intensity emitting from the light source may have a Gaussian distribution with respect to the position of the light source, in determining the luminance coefficient.

In an exemplary embodiment, the light intensity of the light emitting blocks may be normalized to determine the luminance coefficient.

In an exemplary embodiment, the dimming levels of the light emitting blocks may be determined using the input data.

In an exemplary embodiment, the pixel luminance may be determined as a result of multiplying the luminance coefficient corresponding to each of the light emitting blocks by the dimming levels of the light emitting blocks.

In an exemplary embodiment, the compensated data having a grayscale lower than the input data may be generated when the pixel luminance is higher than a maximum emitting luminance. The maximum emitting luminance is a maximum luminance of each of the light emitting blocks. The compensated data having a grayscale higher than the input data may be generated when the pixel luminance is lower than the maximum emitting luminance. The compensated data having a grayscale substantially the same as that of the input data may be generated when the pixel luminance is substantially the same as the maximum emitting luminance.

According to an exemplary embodiment of the present invention, the display apparatus includes a display panel including a plurality of pixels, a light source module, a pixel luminance determiner and a pixel compensator. The light source module includes a plurality of light emitting blocks and provides the display panel with light. The pixel luminance determiner determines a pixel luminance using luminance coefficient and dimming levels of the light source module. The pixel luminance is a luminance of light provided to each pixel of the display panel. The pixel compensator compensates input data using the pixel luminance to generate compensated data.

In an exemplary embodiment, the display apparatus may include a look-up table (LUT) storing the luminance coefficient and outputting the luminance coefficient to the pixel luminance determiner.

In an exemplary embodiment, the display apparatus may include a local dimming driver driving the light source module.

In an exemplary embodiment, the local dimming driver may include a dimming level determiner determining the dimming levels of the input data and a light emitting driver individually driving the light emitting blocks based on the dimming levels.

In an exemplary embodiment, the dimming level determiner may provide the pixel luminance determiner with the dimming levels.

In an exemplary embodiment, the pixel luminance determiner may determine the pixel luminance as a result of multiplying the luminance coefficient corresponding to each of the light emitting blocks by the dimming levels of the light emitting blocks.

In an exemplary embodiment, the light source module may include a light guiding plate disposed on a rear surface of the display panel, and a light emitting module disposed adjacent to at least one relatively longer side of the light guiding plate and including the light emitting blocks arranged in a line.

In an exemplary embodiment, the light source module may include a light guiding plate disposed on a rear surface of the display panel, and a light emitting module disposed adjacent to at least one relatively shorter side of the light guiding plate and including the light emitting blocks arranged in a line.

In an exemplary embodiment, the light source module may be disposed on the rear surface of the display panel, and may include the light emitting blocks arranged in a plurality of lines.

According to an exemplary embodiment of the present invention, the intensity of the light of the light emitting block is calculated using the Gaussian function by considering a luminance change by the adjacent light emitting blocks. Thus, the luminance of the input data is accurately displayed.

Therefore, the response rate is enhanced to prevent a cross-talk phenomenon on a display apparatus such as one that is capable of displaying an impression of a three-dimensional image.

### BRIEF DESCRIPTION OF THE DRAWINGS

The above and other features and aspects of the present invention will become more apparent by describing, in detail, exemplary embodiments thereof with reference to the accompanying drawings, in which:

FIG. 1 is a block diagram illustrating a display apparatus according to an exemplary embodiment of the present invention;

FIG. 2 is a block diagram illustrating a local dimming driver of FIG. 1;

FIG. 3 is a block diagram illustrating a timing controller of FIG. 1;

FIG. 4 is a conceptual diagram illustrating a light intensity provided from a light source of a light emitting block;

FIG. 5 is a result of a simulation using an actual location of the light source of FIG. 1 and a function;

FIG. 6 a flow chart for explaining a method of driving a display panel of FIG. 1;

FIG. 7 is a conceptual diagram of a light source module of a display apparatus according to an exemplary embodiment of the present invention;

FIG. 8 is a result of a simulation using an actual location of the light source of FIG. 7 and a function; and

FIG. 9 is a conceptual diagram of a light source module of a display apparatus according to an exemplary embodiment of the present invention.

### DETAILED DESCRIPTION

Hereinafter, embodiments of the present invention will be explained in detail with reference to the accompanying drawings.

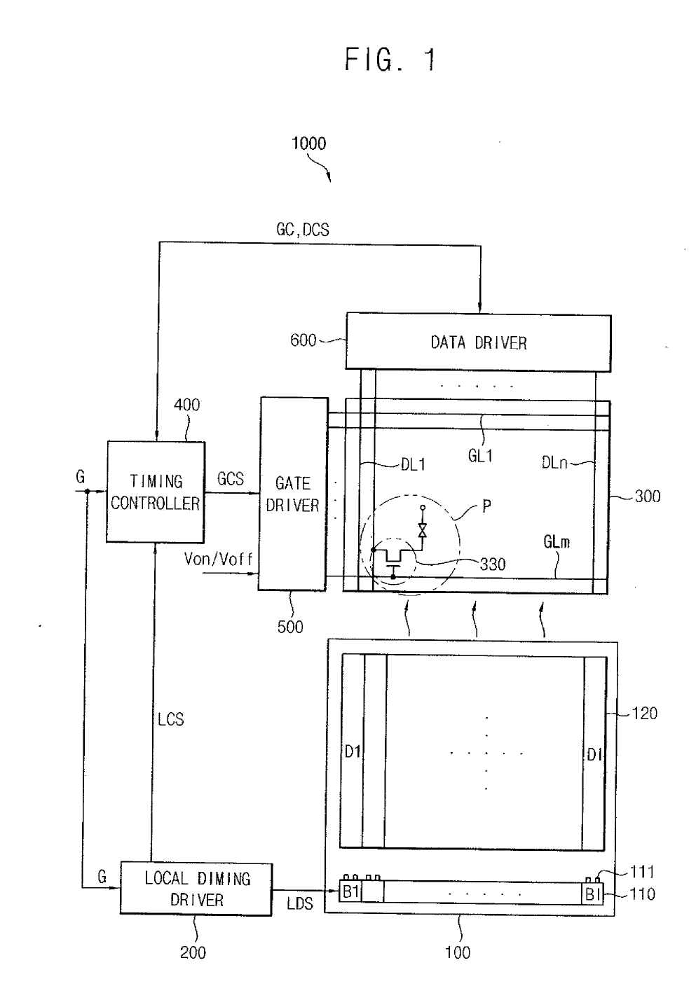

FIG. 1 is a block diagram illustrating a display apparatus according to an exemplary embodiment of the present invention.

Referring to FIG. 1, a display apparatus 1000 includes a light emitting module 100, a local dimming driver 200, a display panel 300, a timing controller 400, a gate driver 500 and a data driver 600.

The light source module 100 provides the display panel 300 with light. The light source module 100 includes a light emitting module 110 and a light guiding plate 120.

The light emitting module 110 may include a fluorescent lamp or one or more light emitting diodes. The light emitting module 110 may be disposed adjacent to a relatively longer edge of the light guiding plate 120.

The light emitting module 110 is divided into a plurality of light emitting blocks B. A luminance of each of the light emitting blocks B is individually controlled to be driven via a local dimming method. The light emitting module 110 as shown in FIG. 1 may have a one-dimension local dimming structure having I-number of the light emitting blocks B1, . . . , BI arranged along a first direction D1. Herein, I is a positive integer.

The light guiding plate 120 includes a plurality of light guiding blocks D respectively corresponding to the light emitting blocks B. The light guiding blocks D may be defined by dividing the light guiding plate 120 into areas respectively corresponding to the light emitting blocks B. Alternatively, the light guiding plate 120 is formed by combining a plurality of individual blocks, and the light guiding blocks D may be defined by the individual blocks. The light guiding plate 120 guides light generated from the light emitting module 110 toward the display panel 300.

Each of the light emitting blocks of the light source module 100 having the local dimming structure may be affected by a luminance of the light emitting blocks adjacent to each other.

The local dimming driver 200 controls a luminance of light provided to the display panel 300 based on input data G The local dimming driver 200 generates a light source control signal LCS based on the input data G to control the light source module 100. The light source control signal LCS individually controls each of the light emitting blocks B. The local dimming driver 200 provides the timing controller 400 with the light source control signal LCS. An operation of the local dimming driver 200 is explained in detail below.

The display panel 300 includes a plurality of gate lines GL1 through GLm, a plurality of data lines DL1 through DLn and a plurality of pixels P. The gate lines GL1 through GLm extend along the first direction D1. The data lines DL1 through DLn extend along a second direction D2 crossing the first direction D1. Each of the pixels P includes a switching element 330 connected to each of the gate lines GL1 through GLm and each of the data lines DL1 through DLn, and a pixel electrode (not shown) electrically connected to the switching element 330.

The timing controller 400 provides the gate driver 500 with a gate control signal GCS. In addition, the timing controller 400 provides the data driver 600 with compensated data GC and data control signals DCS. The gate and data control signals GCS and DCS controls a display of the display panel 300.

The timing controller 400 compensates the input data G based on the light source control signal LCS provided from the local dimming driver 200 and generates the compensated data GC. An operation of the timing controller 400 is described in detail below.

The gate driver 500 is connected to end portions of the gate lines GL1 through GLm. The gate driver 500 generates a plurality of gate signals using the gate control signal GCS provided from the timing controller 400 and gate on/off voltages (not shown) provided from a voltage generator (not shown). The gate driver 500 sequentially applies the gate signals to the gate lines GL1 through GLm arranged on the display panel 300.

The gate driver 500 may include a plurality of gate driving ICs (not shown). The gate driving ICs may include a plurality of switching elements directly formed in a peripheral area of the display panel 300 in forming the switching element 330 of the pixel P in a display area of the display panel 300, at the same time.

The data driver 600 is connected to end portions of the data lines DL1 through DLn. The data driver 600 receives the compensated data GC and the data control signal DCS from the timing controller 400, and grayscale voltages from a grayscale voltage generator (not shown). The data driver 600 converts the compensated data GC into an analogue data voltage based on the grayscale voltages, and applies the analogue data voltage to the data lines DL1 through DLn arranged on the display panel 300.

The data driver 600 may include a plurality of data driving ICs (not shown).

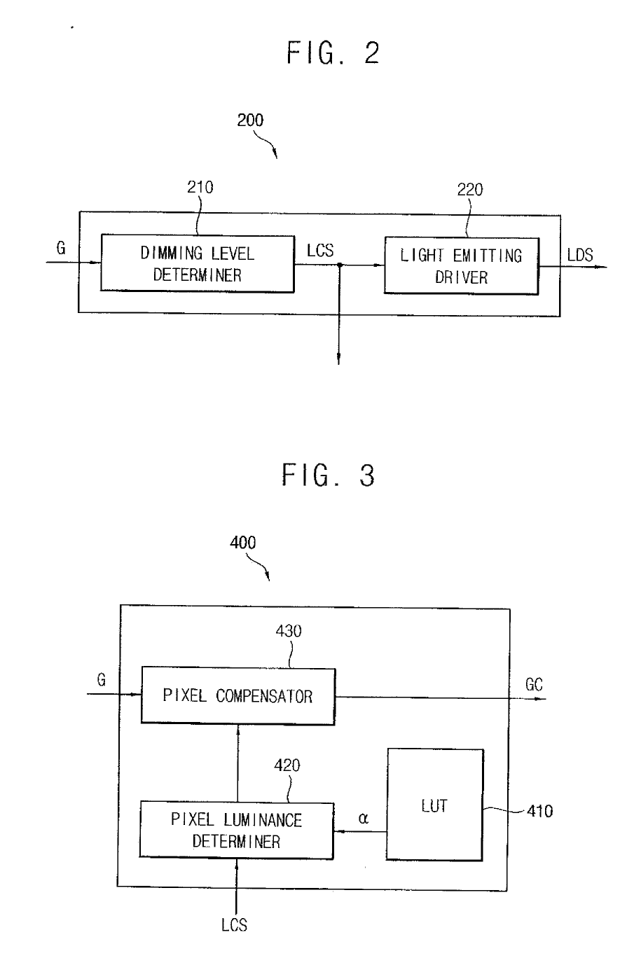

FIG. 2 is a block diagram illustrating a local dimming driver of FIG. 1.

Referring to FIG. 2, the local dimming driver 200 includes a dimming level determiner 210 and a light emitting driver 220.

The dimming level determiner 210 divides the input data G into a plurality of image blocks respectively corresponding to the light emitting blocks B of the light emitting module 110. The dimming level determiner 210 calculates a representative grayscale of the image block, for example, using a histogram, according to the grayscale of the input data G included in each image block. The representative grayscale may be an average grayscale or a maximum grayscale of the input data G included in the image block. The dimming level determiner 210 determines dimming levels of the light emitting blocks B using the representative grayscales of the image blocks, and generates the light source control signal LCS including the dimming levels. Although not shown in figures, the dimming level determiner 210 may temporally and spatially compensate the dimming level using a low-pass filter.

The light emitting driver 220 generates light source driving signals LDS driving the light emitting blocks B of the light emitting module 110 based on the light source control signal LCS. Each of the light source driving signals LDS may be a pulse width modulation (PWM) signal in which a pulse-width of a signal is modulated according to a size of a modulation signal, and the dimming level may correspond to a duty ratio of the PWM signal.

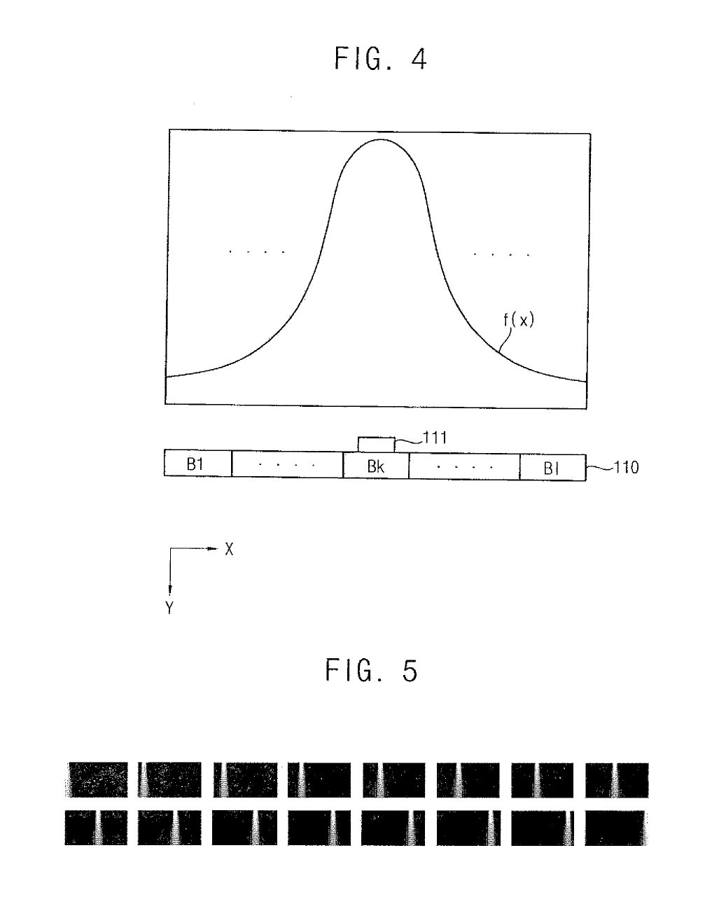

FIG. 3 is a block diagram illustrating a timing controller of FIG. 1. FIG. 4 is a conceptual diagram illustrating a light intensity provided from a light source of a light emitting block. FIG. 5 is a result of a simulation using an actual location of the light source of FIG. 1 and a function.

Referring to FIG. 3, the timing controller 400 includes a look-up table (LUT, 410), a pixel luminance determiner 420 and a pixel compensator 430.

The LUT 410 stores a luminance coefficient a used for determining a luminance of a pixel at the pixel luminance determiner 420. The luminance coefficient a may be calculated externally and in advance, for example, using a simulation computer, and stored at the LUT 410. A process of determining the luminance coefficient a is as follows.

Referring to FIG. 4, the light emitting blocks B are arranged along an X direction X. A light provided from a K-th light emitting block BK of the light emitting module 110 is provided to adjacent light emitting blocks B1 . . . Bk−1, Bk+1 . . . BI. For example, the light provided from the K-th light emitting block BK affects both a luminance of the K-th light emitting block BK and a luminance of each of the adjacent light emitting blocks B1 . . . Bk−1, Bk+1 . . . BI. Therefore, if it is assumed that light of one light source is equally provided to each of the light emitting blocks B, the input data G will not be accurately displayed.

Thus, a luminance of the pixel P is calculated by considering a luminance change due to the adjacent light emitting blocks B1 . . . Bk−1, Bk+1 . . . BI.

A light intensity provided by one light source 111 is represented as Gaussian function f(x). Thus, the light intensity provided from one light source 111 at a certain position x is as follows.

f(x)=e^{-x}^{²} [Function 1]

It is assumed that the K-th light emitting block BK includes N-number of the light sources. Each of the N-number of the light sources does not provide the certain position x of the K-th light emitting block BK with light having substantially same intensity with each other. The N-number of the light sources provides the certain position x of the K-th light emitting block BK with light having the intensity different from each other according to each position of the N-number of the light sources. Thus, the sum of the Gaussian function f(x) according to each position of the N-number of the light sources is a light intensity of the K-th light emitting block BK.

Each position of the N-number of the light sources is represented as {p_{k,1}, p_{k,2}, . . . , p_{k,N}}. Thus, the light intensity at the certain position x of the K-th light emitting block BK is as follows.

$${f}_{k} ( x ) = {\sum }_{i = 1}^{N} {e}^{- {( x - {p}_{k , i} )}^{2}} \qquad [ Function 2 ]$$

A function σ(y) represents light of the K-th light emitting block BK spreading along a Y direction Y. The Y direction Y is substantially vertical to the X direction X. The function σ(y) may be represented by a linear function as follows.

σ(y)=a×y+b [Function 3]

The constants a and b determine an amount of light spreading in a pan shape.

Thus, when considering the function σ(y), the light intensity at the certain position (x, y) of the K-th light emitting block BK is as follows.

$${f}_{k} ( x , y ) = {\sum }_{i = 1}^{N} {e}^{- {( \frac{x - {p}_{k , i }}{σ ( y )} )}^{2}} \qquad [ Function 4 ]$$

Using Function 4, the light intensity is normalized along the Y direction Y to represent that total amount of the light provided from the light emitting module 110 is constant.

The normalized light intensity at the certain position (x, y) of the K-th light emitting block BK is as follows.

gₖ(x, y)=fₖ(x, y)/∫_{-∞}^{∞}fₖ(t, y)dt [Function 5]

The function gₖ (x, y) is a function representing the light intensity of the K-th light emitting block BK.

FIG. 5 is a result of a simulation in which an actual location is assigned to the function gₖ (x, y). The sum of intensities of light emitting from each light source of the light emitting blocks B based on the simulation result determines a luminance of each pixel P.

The luminance of each pixel P is as follows.

$$L ( x , y ) = {\sum }_{k = 1}^{I} C ( k ) \times {g}_{k} ( x , y ) \qquad [ Function 6 ]$$

The function L(x, y) represents a final luminance of each pixel P. The function C(k) is an output intensity of a light source at the K-th light emitting block BK based on the light source control signal LCS. The function C(k) may be the PWM signal or the duty ratio of the PWM signal.

The LUT 410 stores a result of the gₖ(x, y) calculated from the external simulation computer as the luminance coefficient α. For example, the LUT 410 may sample some results of the gₖ (x, y) corresponding to each pixel P and store the sample results as the luminance coefficient α. Regarding the pixels P in which the luminance coefficient α is not stored at the LUT 410, a luminance is determined by interpolating each luminance of the adjacent pixels P. Alternatively, the LUT 410 may store all results of the gₖ (x, y) corresponding to each pixel P as the luminance coefficient α.

The luminance coefficient α calculated by the external simulation computer is stored at LUT 410, so that the display apparatus 1000 does not need to repeat a calculation of Function 6 whenever the input data G are received.

In addition, although the light source module is changed, the luminance coefficient stored in the LUT is only changed using a function suitable for the changed light source module, so that compatibility for the light source module is enhanced.

The pixel luminance determiner 420 determines a luminance distribution of the light provided to the display panel 300 based on the light source control signal LCS provided from the dimming level determiner 210 and the luminance coefficient a provided from the LUT 410. The pixel luminance determiner 420 determines a luminance of each pixel P of the display panel 300 using the luminance distribution of light. Hereinafter, the luminance of each pixel P is referred to as a pixel luminance.

The pixel luminance is determined using Function 6. The duty ratio of the PWM signal corresponds to the function C(k), and the luminance coefficient a from the LUT 410 corresponds to the function gₖ (x, y).

The pixel compensator 430 compensates the input data G to generate the compensated data GC. A pixel compensating relation of the pixel compensator 430 is as follows.

According to some exemplary embodiments, the light emitting blocks B are arranged along the X direction as shown in FIG. 1, but an arrangement of the light emitting blocks B is not limited thereof and may be variously changed.

$$GC = {( \frac{{L}_{minwhite}}{{L}_{pixelwhite}} )}^{\frac{1}{γ}} \times G \qquad [ Function 7 ]$$

A maximum emitting luminance L_{minwhite} is lower than a maximum white luminance L_{maxwhite}. The maximum white luminance L_{maxwhite} is a luminance when the light source module 100 is driven as a full-white mode (e.g., full brightness). For example, the maximum emitting luminance L_{minwhite} may be a maximum luminance of one light emitting block B of the light source module 100.

For example, first, second and third cases are examined. The first case is that a first pixel luminance L_{pixellight}1 is provided to, the pixel P having the transmissivity of a white-grayscale by lighting one light emitting block B. The second case is that a second pixel luminance L_{pixellight}2 is provided to the pixel P having the transmissivity of the white-grayscale by lighting the plurality of light emitting blocks B. The third case is that a third pixel luminance L_{pixellight}3 is provided to the pixel P having the transmissivity of the white-grayscale by lighting all of the light emitting blocks B. It is assumed that the first pixel luminance L_{pixellight}1 is “250,” the second pixel luminance L_{pixellight}2 is “251,” and the third pixel luminance L_{pixellight}3 is “255.” In addition, it is assumed that the maximum emitting luminance L_{minwhite} is substantially the same as the first pixel luminance L_{pixellight}1, and the maximum white luminance L_{maxwhite} is substantially the same as the third pixel luminance L_{pixellight}3.

In the first case, the compensated data GC has a “255” grayscale substantially same as the input data G according to Function 7. In the second case, the compensated data GC has a “255×(0.99)C” grayscale according to Function 7. Herein, C is 1/γ. In the third second case, the compensated data GC has a “255×(0.98)C” grayscale according to Function 7.

When the pixel P corresponding to the compensated data GC in the first case has a first transmissivity, the pixel P corresponding to the compensated data GC in the second case has a second transmissivity lower than the first transmissivity. In addition, the pixel P corresponding to the compensated data GC in the third case has a third transmissivity lower than the second transmissivity.

When the pixel luminance L_{pixellight} provided to an arbitrary pixel P is lower than the maximum emitting luminance L_{minwhite}, the pixel compensator 430 generates the compensated data GC having a grayscale higher than the input data G. When the pixel luminance L_{pixellight} is substantially the same as the maximum emitting luminance L_{minwhite}, the pixel compensator 430 generates the compensated data GC having a grayscale substantially the same as that of the input data G. In addition, when the pixel luminance L_{pixellight} is higher than the maximum emitting luminance L_{minwhite}, the pixel compensator 430 generates the compensated data GC having a grayscale lower than the input data G Thus, the input data G are compensated according to the pixel luminance L_{pixellight} to display an original grayscale.

According to exemplary embodiments, the intensity of the light of the light emitting block is calculated using the Gaussian function, and the result of the calculation is stored at the LUT as the luminance coefficient. In addition, the luminance coefficient is determined by considering a luminance change due to the adjacent light emitting blocks.

The pixel compensator compensates the input data to have a relatively low grayscale when the pixel luminance is higher than the maximum emitting luminance, so that the transmissivity of the pixel is decreased. Thus, the luminance of the input data is accurately displayed.

In addition, the luminance coefficient calculated by the external simulation computer is stored at the LUT, so that the display apparatus does not need to repeatedly calculate the luminance coefficient whenever the input data are received. Thus, although the light source module is changed, the luminance coefficient stored in the LUT is only changed using a function suitable for the changed light source module, so that compatibility for the light source module is enhanced.

According to an exemplary embodiment of the present invention, a response rate for light is increased, so that a motion picture reaction time (MPRT) may be prevented from decreasing due to the light. Thus, when a three-dimensional (3D) display apparatus is driven, the response rate of the display panel for a left-eye image and a right-eye image is enhanced to prevent a cross-talk from occurring on the 3D display apparatus.

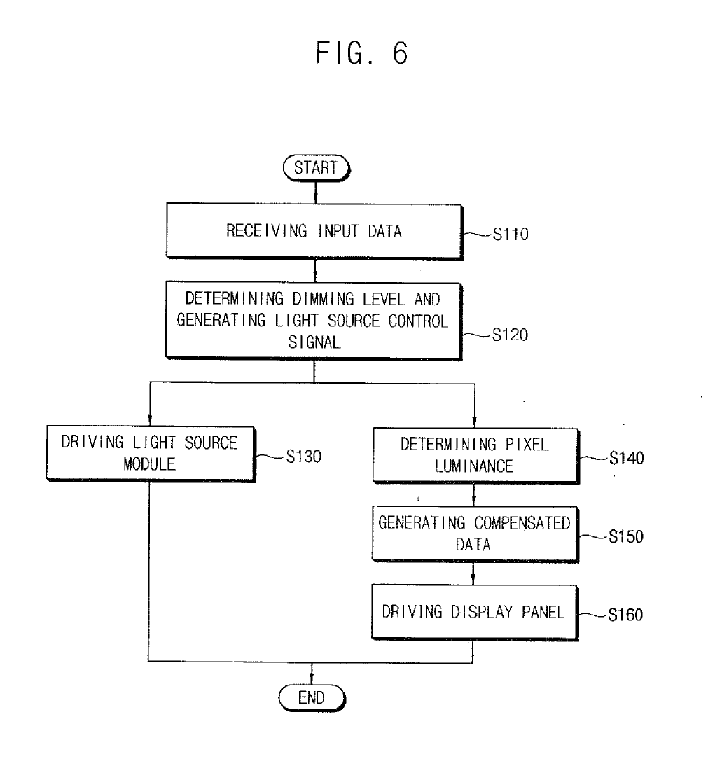

FIG. 6 a flow chart for explaining a method of driving a display panel of FIG. 1.

Referring to FIG. 6, the dimming level determiner 210 receives the input data G from an external source (step S110).

The dimming level determiner 210 divides the input data G into the image blocks corresponding to the light emitting blocks B of the light emitting module 110. The dimming level determiner 210 determines the dimming levels of the light emitting blocks B using the representative grayscales of the image blocks, and generates the light source control signal LCS. The dimming level determiner 210 provides the light source control signal LCS to the pixel luminance determiner 420 of timing controller 400 and the light emitting driver 220 (step S120).

The light emitting driver 220 generates the light source driving signals LDS controlling a luminance of each of the light emitting blocks B based on the light source control signal LCS, and provides the light emitting blocks B with the light source driving signals LDS. Thus, the light emitting blocks B are driven via a local dimming method (step S130).

In addition, the pixel luminance determiner 420 determines the pixel luminance L_{pixellight} based on the light source control signal LCS provided from the dimming level determiner 210 and the luminance coefficient a provided from the LUT 410 (step S140). The pixel luminance L_{pixellight} is provided to each of the pixels P.

The luminance coefficient a is calculated using an external simulation computer using Function 6, and is stored at the LUT 410. The luminance coefficient a is calculated using the assumption that light provided from the light emitting block B is distributed along the Gaussian function.

The pixel compensator 430 compensates the input data G to generate the compensated data GC using the pixel compensating relation of Function 7 (step S150). When the pixel luminance L_{pixellight} provided to an arbitrary pixel P is lower than the maximum emitting luminance L_{minwhite}, the pixel compensator 430 generates the compensated data GC having a grayscale higher than the input data G. When the pixel luminance L_{pixellight} is substantially the same as the maximum emitting luminance L_{minlight}, the pixel compensator 430 generates the compensated data GC having a grayscale substantially the same as that of the input data G In addition, when the pixel luminance L_{pixellight} is higher than the maximum emitting luminance L_{minwhite}, the pixel compensator 430 generates the compensated data GC having a grayscale lower than the input data G.

The timing controller 400 provides the compensated data GC from the pixel compensator 430 to the data driver 600.

The data driver 600 converts the compensated data GC into an analogue data voltage, and applies the analogue data voltage to the data lines DL1 through DLn. A compensated image is displayed on the display panel 300 according to a brightness of the light emitting blocks B driven via the local dimming method (step S160).

According to exemplary embodiments, the intensity of the light of the light emitting block is calculated using the Gaussian function by considering a luminance change due to the adjacent light emitting blocks, and the result of the calculation is stored at the LUT as the luminance coefficient. The pixel compensator compensates the input data based on the luminance coefficient. Thus, the luminance of the input data is accurately displayed.

In addition, the luminance coefficient calculated by the external simulation computer is stored at the LUT, so that the display apparatus do not need to repeatedly calculate the luminance coefficient whenever the input data are received. However, according to other exemplary embodiments of the present invention, calculation of the luminance coefficient may be performed on-the-fly locally within the display device and luminance coefficients need not be pre-calculated using an external simulation computer.

A luminance calculation of each pixel is quick and easy, and a response rate for light of the display panel is increased, so that the MPRT may be prevented from decreasing due to the light. Thus, when a 3D display apparatus is driven, the response rate of the display panel for a left-eye image and a right-eye image is enhanced to prevent a cross-talk from occurring on the 3D display apparatus.

In addition, although the light source module is changed, the luminance coefficient stored in the LUT is only changed using a function suitable for the changed light source module, so that compatibility for the light source module is enhanced.

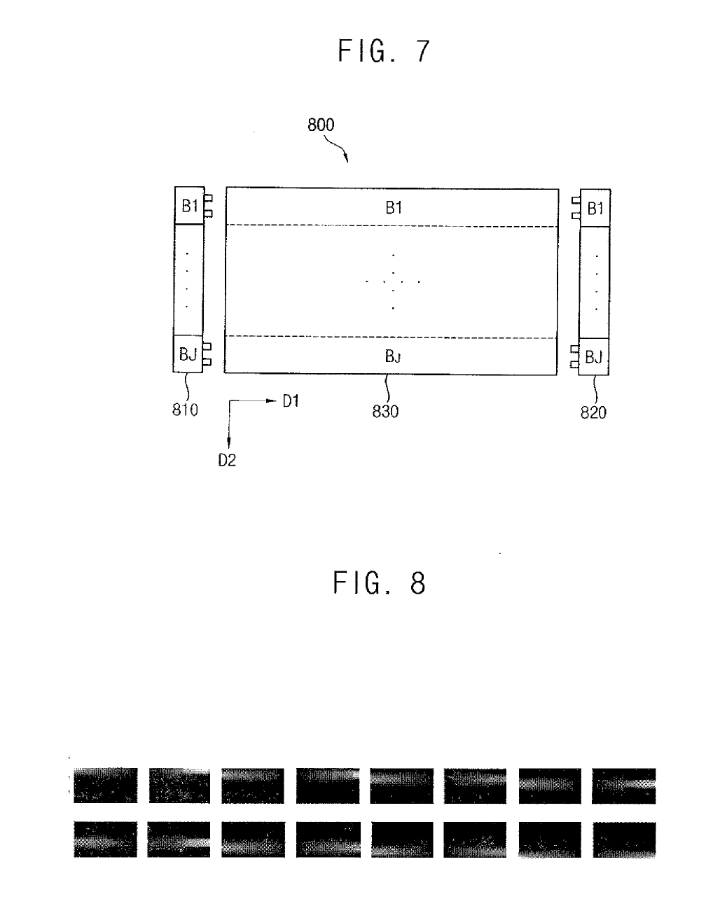

FIG. 7 is a conceptual diagram of a light source module of a display apparatus according to an exemplary embodiment of the present invention. FIG. 8 is a result of a simulation using an actual location of the light source of FIG. 7 and a function.

A display apparatus according to an exemplary embodiment may be substantially the same as the display apparatus described above with reference to FIGS. 1 to 6 except for a light source module, so that the same reference numerals may be used to refer to the same or like parts as those described above.

Referring to FIGS. 1 and 7, a light source module 800 provides the display panel 300 with light. The light source module 800 includes first and second light emitting modules 810 and 820 and a light guiding plate 830.

The first and second light emitting modules 810 and 820 are respectively disposed adjacent to relatively shorter edges of the light guiding plate 830, for example, as shown. The first and second light emitting modules 810 and 820 are disposed at the relatively shorter edges of the light guiding plate 830 and are positioned opposite to each other. The first and second light emitting modules 810 and 820 may include a fluorescent lamp or one or more light emitting diodes.

The first and second light emitting modules 810 and 820 are respectively divided into the light emitting blocks B. Each luminance of the light emitting blocks B is individually controlled to be driven via the local dimming method. The first and second light emitting modules 810 and 820 as shown in FIG. 7 may have a one-dimension local dimming structure including J-number of the light emitting blocks B1, . . . , BJ arranged along the second direction D2. Herein, J is a positive integer.

The light guiding plate 830 includes a plurality of light guiding blocks D corresponding to the light emitting blocks B. The light guiding blocks D may be defined by dividing the light guiding plate 830 into areas respectively corresponding to the light emitting blocks B. Alternatively, the light guiding plate 830 is formed by combining a plurality of individual blocks, and the light guiding blocks D may be defined by the individual blocks. The light guiding plate 830 guides light generated from the light emitting modules 810 and 820 toward the display panel 300.

A simulation of light emitting of the light emitting modules 810 and 820 disposed adjacent to the relatively shorter edges of the light guiding plate 830 is shown in FIG. 8. Each of the light emitting blocks B of the light source module 800 having the local dimming structure may be affected by the adjacent light emitting blocks B.

Thus, the pixel luminance provided to the pixels is calculated by considering the luminance change due to the adjacent light emitting blocks, and the input data are compensated based on the pixel luminance, so that a contrast ratio of the display panel is enhanced.

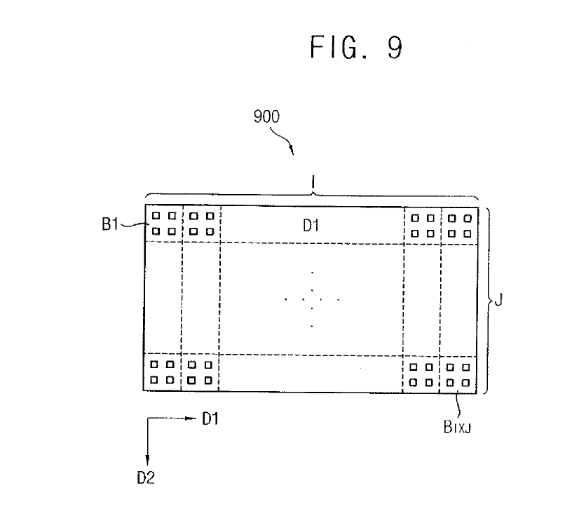

FIG. 9 is a conceptual diagram of a light source module of a display apparatus according to an exemplary embodiment of the present invention.

A display apparatus according to an exemplary embodiment may be substantially the same as the display apparatus described above with reference to FIGS. 1 to 6 except for a light source module, so that the same reference numerals will be used to refer to the same or like parts as those described above.

Referring to FIGS. 1 and 9, a light source module 900 provides the display panel 300 with light.

The light source module 900 is divided into the light emitting blocks B. A luminance of each of the light emitting blocks is individually controlled to be driven via the local dimming method. The light emitting block B may include at least one light emitting diode. The light emitting diodes are disposed on a rear surface of the display panel 300, and have a 2-dimensional matrix structure. The light source module 900 as shown in FIG. 9 may have a 2-dimension local dimming structure including I-number of the light emitting blocks B arranged along the first direction D1 and J-number of the light emitting blocks B arranged along the second direction D2, so that the light source module 600b totally includes I×J number of the light emitting blocks (B₁, . . . , B_{I×J}).

Each of the light emitting blocks B of the light source module 900 having the local dimming structure may be affected by the adjacent light emitting blocks B.

Thus, the pixel luminance provided to the pixels is calculated by considering the luminance change due to the adjacent light emitting blocks, and the input data are compensated based on the pixel luminance, so that a contrast ratio of the display panel is enhanced.

According to an exemplary embodiment of the present invention, the intensity of the light of the light emitting block is calculated using the Gaussian function by considering a luminance change due to the adjacent light emitting blocks, and the result of the calculation is stored at the LUT as the luminance coefficient. Thus, the luminance of the input data is accurately displayed.

In addition, the luminance coefficient calculated by the external simulation computer is stored at the LUT, so that the display apparatus does not need to repeatedly calculate the luminance coefficient whenever the input data are received. However, according to other exemplary embodiments of the present invention, calculation of the luminance coefficient may be performed on-the-fly locally within the display device and luminance coefficients need not be pre-calculated using an external simulation computer.

A luminance calculation of each pixel is quick and easy, and a response rate for light of the display panel is increased, so that the MPRT may be prevented from decreasing by the light. Thus, when a 3D display apparatus is driven, the response rate of the display panel for a left-eye image and a right-eye image is enhanced to prevent a cross-talk from occurring on the 3D display apparatus.

In addition, although the light source module is changed, the luminance coefficient stored in the LUT is only changed using a function suitable for the changed light source module, so that compatibility for the light source module is enhanced.

The foregoing is illustrative of the present invention and is not to be construed as limiting thereof. Although a few exemplary embodiments of the present invention have been described, those skilled in the art will readily appreciate that many modifications are possible in the exemplary embodiments described herein without materially departing from the present invention.

What is claimed is:

1. A method for driving a display panel, the method comprising:
determining a plurality of luminance coefficients corresponding to a plurality of light emitting blocks included in a light source module using a Gaussian function;
determining a section luminance using a corresponding luminance coefficient of the plurality of luminance coefficients and a dimming level of a corresponding light emitting block of the plurality of light emitting blocks, the section luminance being a luminance of light provided to each of a plurality of sections of the display panel; and
compensating input data using the section luminance to generate compensated data.

2. The method of claim 1, wherein each section corresponds to a single pixel of the display panel.

3. The method of claim 1, wherein each section corresponds to a group of multiple pixels of the display device.

4. The method of claim 1, wherein determining the luminance coefficients comprises:
adding up intensities of the light emitting from light sources included in the light emitting blocks, a relative weight of which is determined according to relative positions of the light sources to determine a light intensity of the light emitting blocks.

5. The method of claim 4, wherein the light intensity emitting from the light source is estimated to have a Gaussian distribution with respect to the position of the light source, in determining the luminance coefficient.

6. The method of claim 4, wherein determining the luminance coefficient comprises:
normalizing the light intensity of the light emitting blocks to determine the luminance coefficient.

7. The method of claim 1, wherein determining the section luminance comprises:
determining the dimming levels of the light emitting blocks using the input data.

8. The method of claim 7, wherein determining the section luminance further comprises:
determining the section luminance as a result of multiplying the luminance coefficient corresponding to each of the light emitting blocks by the dimming levels of the light emitting blocks.

9. The method of claim 1, wherein generating the compensated data comprises:
generating the compensated data having a grayscale lower than the input data when the section luminance is higher than a maximum emitting luminance, the maximum emitting luminance being a maximum luminance of each of the light emitting blocks;
generating the compensated data having a grayscale higher than the input data when the pixel luminance is lower than the maximum emitting luminance; and
generating the compensated data having a grayscale substantially the same as that of the input data when the section luminance is substantially the same as the maximum emitting luminance.

10. A display apparatus comprising:
a display panel including a plurality of pixels;
a light source module including a plurality of light emitting blocks, and the light source module providing the display panel with light;
a pixel luminance determiner determining a pixel luminance using luminance coefficient and dimming levels of the light emitting block, the pixel luminance being a luminance of light provided to corresponding groups of pixels of the display panel; and
a pixel compensator compensating input data using the pixel luminance to generate compensated data.

11. The display apparatus of claim 10, further comprising:
a look-up table (LUT) storing the luminance coefficient and outputting the luminance coefficient to the pixel luminance determiner.

12. The display apparatus of claim 10, wherein the luminance coefficient is determined by a light intensity of the light emitting block, and
the light intensity of the light emitting block is the sum of intensities of the light emitting from light sources included in the light emitting blocks according to positions of the light sources.

13. The display apparatus of claim 12, wherein the light intensity emitting from the light source is estimated to have a Gaussian distribution with respect to the position of the light source.

14. The display apparatus of claim 12, wherein the luminance coefficient is a normalized value of the light intensity of the light emitting block.

15. The display apparatus of claim 10, further comprising:
a local dimming driver driving the light source module.

16. The display apparatus of claim 15, wherein the local dimming driver comprises:
a dimming level determiner determining the dimming levels of the input data; and
a light emitting driver individually driving the light emitting blocks based on the dimming levels.

17. The display apparatus of claim 16, wherein the dimming level determiner provides the pixel luminance determiner with the dimming levels.

18. The display apparatus of claim 10, wherein the pixel luminance determiner determines the pixel luminance as a result of multiplying the luminance coefficient corresponding to each of the light emitting blocks by the dimming levels of the light emitting blocks.

19. The display apparatus of claim 10, wherein the pixel compensator generates the compensated data having a grayscale lower than the input data when the pixel luminance is higher than the maximum emitting luminance which is a maximum luminance of each of the light emitting blocks,
the pixel compensator generates the compensated data having a grayscale higher than the input data when the pixel luminance is lower than the maximum emitting luminance, and
the pixel compensator generates the compensated data having a grayscale substantially the same as that of the input data when the pixel luminance is substantially the same as the maximum emitting luminance.

20. The display apparatus of claim 10, wherein the light source module comprises:
a light guiding plate disposed on a rear surface of the display panel; and
a light emitting module disposed adjacent to at least one relatively longer side of the light guiding plate, wherein the light emitting blocks are arranged in a line.

21. The display apparatus of claim 10, wherein the light source module comprises:
a light guiding plate disposed on a rear surface of the display panel; and
a light emitting module disposed adjacent to at least one relatively shorter side of the light guiding plate, wherein the light emitting blocks are arranged in a line.

22. The display apparatus of claim 21, wherein the light source module is disposed on the rear surface of the display panel, and includes the light emitting blocks arranged in a plurality of lines.
